(19) United States
(12) Patent Application Publication
(10) Pub. No.: US 2017/0291362 A1
(43) Pub. Date: Oct. 12, 2017

(54) PRINTING 3D PARTS WITH CONTROLLED SURFACE FINISH

(71) Applicant: Eastman Kodak Company, Rochester, NY (US)

(72) Inventors: Thomas Nathaniel Tombs, Rochester, NY (US); Cumar Sreekumar, Penfield, NY (US)

(21) Appl. No.: 15/091,789

(22) Filed: Apr. 6, 2016

(51) Int. Cl. B29C 67/00

(52) U.S. Cl. CPC B29C 67/0081; B29C 67/0092; B29K 2033/12

(57) ABSTRACT

A 3D part and a support structure is printed using an electrophotography-based additive manufacturing system. A support layer of the support structure is developed with a first electrophotography engine using a support material and transferred to a transfer medium. A large-particle part layer corresponding to a first portion of the 3D part is developed with a second electrophotography engine using a first part material and transferred to a transfer medium, and a plurality of small-particle part layers corresponding to a second portion of the 3D part are developed with one or more additional electrophotography engines using a second part material and transferred to a transfer medium. An average size of the first part material particles is at least two times that of the second part material particles. The transferred support layer, large-particle part layer and small-particle part layers are transfused to previously-printed layers using a layer transfusion assembly.

### CROSS-REFERENCE TO RELATED APPLICATIONS

Reference is made to commonly assigned, co-pending U.S. Patent Application Ser. No. 62/286,490, entitled: “Large format electrophotographic 3D printer,” by C. Sreekumar et al., which is incorporated herein by reference.

### FIELD OF THE INVENTION

This invention pertains to the field of additive manufacturing systems for printing three-dimensional parts and support structures, and more particularly to a system for printing three-dimensional parts with a controlled surface finish.

### BACKGROUND OF THE INVENTION

Additive manufacturing systems are used to build three-dimensional (3D) parts from digital representations of the 3D parts using one or more additive manufacturing techniques. Common forms of such digital representations would include the well-known AMF and STL file formats. Examples of commercially available additive manufacturing techniques include extrusion-based techniques, ink jetting, selective laser sintering, powder/binder jetting, electron-beam melting, and stereolithographic processes. For each of these techniques, the digital representation of the 3D part is initially sliced into a plurality of horizontal layers. For each sliced layer, a tool path is then generated, that provides instructions for the particular additive manufacturing system to form the given layer.

For example, in an extrusion-based additive manufacturing system, a 3D part (sometimes referred to as a 3D model) can be printed from the digital representation of the 3D part in a layer-by-layer manner by extruding a flowable part material. The part material is extruded through an extrusion tip carried by a printhead of the system, and is deposited as a sequence of layers on a substrate in an x-y plane. The extruded part material fuses to previously deposited part material, and solidifies upon a drop in temperature. The position of the printhead relative to the substrate is then incremented along a z-axis (perpendicular to the x-y plane), and the process is then repeated to form a 3D part resembling the digital representation.

In fabricating 3D parts by depositing layers of a part material, supporting layers or structures are typically built underneath overhanging portions or in cavities of objects under construction, which are not supported by the part material itself. A support structure may be built utilizing the same deposition techniques by which the part material is deposited. The host computer generates additional geometry defining the support structure for the overhanging or free-space segments of the 3D part being formed, and in some cases, for the sidewalls of the 3D part being formed. The support material adheres to the part material during fabrication, and is removable from the completed 3D part when the printing process is complete.

In two-dimensional (2D) printing, electrophotography (also known as xerography) is a technology for creating 2D images on planar substrates, such as printing paper and transparent substrates. Electrophotography systems typically include a conductive support drum coated with a photoconductive material layer, where latent electrostatic images are formed by electrostatic charging, followed by image-wise exposure of the photoconductive layer by an optical source. The latent electrostatic images are then moved to a developing station where toner is applied to charged areas, or alternatively to discharged areas of the photoconductive insulator to form visible images. The formed toner images are then transferred to substrates (e.g., printing paper) and affixed to the substrates with heat and/or pressure.

U.S. Pat. No. 9,144,940 (Martin), entitled “Method for printing 3D parts and support structures with electrophotography-based additive manufacturing,” describes an electrophotography-based additive manufacturing method that is able to make a 3D part using a support material and a part material. The support material compositionally includes a first charge control agent and a first copolymer having aromatic groups, (meth)acrylate-based ester groups, carboxylic acid groups, and anhydride groups. The part material compositionally includes a second charge control agent, and a second copolymer having acrylonitrile units, butadiene units, and aromatic units.

The method described by Martin includes developing a support layer of the support structure from the support material with a first electrophotography engine, and transferring the developed support layer from the first electrophotography engine to a transfer medium. The method further includes developing a part layer of the 3D part from the part material with a second electrophotography engine, and transferring the developed part layer from the second electrophotography engine to the transfer medium. The developed part and support layers are then moved to a layer transfusion assembly with the transfer medium, where they are transfused together to previously-printed layers. The layer transfusion assembly can use any type of transfusion process known in the art to transfers the layers and fuse them to the previously-printed layers. In an exemplary configuration the layer transfusion assembly uses a heat process. However, other types of transfusion processes such as solvent processes can also be used in accordance with the present invention.

Electrophotographic printing typically uses small particles to print an image. Typical two-dimensional printed images are very thin, usually between 3 and 10 microns. Smaller particles produce thinner layers than larger particles. If a small sized toner is used to in electrophotographic 3D printing then the time it takes to build a 3D object is substantially longer than it would be with a larger sized toner because each layer printed is thinner with the smaller toner. However, if large particles are used, then the resolution of the printing process is reduced compared to when small particles are used. This reduction in resolution reduces the ability to the control the surface finish of a 3D printed object.

There remains a need to for improved 3D printing methods that will provide high speed printing providing a high resolution and a controlled surface finish.

### SUMMARY OF THE INVENTION

The present invention represents a method for printing a three-dimensional part and a support structure with an electrophotography-based additive manufacturing system, the method includes:

providing a removable support material compositionally including support material particles;

providing a first part material compositionally including first part material particles;

providing a second part material compositionally including second part material particles, wherein an average size of the first part material particles is at least two times an average size of the second part material particles;

developing a support layer of the support structure from the support material with a first electrophotography engine;

transferring the developed support layer from the first electrophotography engine to a transfer medium;

developing a large-particle part layer corresponding to a predefined first portion of the three-dimensional part from the first part material with a second electrophotography engine;

transferring the developed large-particle part layer from the second electrophotography engine to the transfer medium;

developing a plurality of small-particle part layers corresponding to a predefined second portion of the three-dimensional part from the second part material with one or more additional electrophotography engines;

transferring the developed small-particle part layers from the one or more additional electrophotography engines to the transfer medium; and

transfusing the transferred support layer, large-particle part layer and small-particle part layers together to previously-printed layers using a layer transfusion assembly.

This invention has the advantage that it increases the speed that a high resolution 3D printed object can be printed using an electrophotographic process.

It has the further advantage of enhancing the control of the surface finish of a 3D printed object so that a broad range of surface finishes can be created.

### BRIEF DESCRIPTION OF THE DRAWINGS

FIG. 1 is a schematic front view of an exemplary electrophotography-based additive manufacturing system for printing 3D parts and support structures from part and support materials;

FIG. 2 is a schematic front view showing additional details of the electrophotography engines in the additive manufacturing system of FIG. 1;

FIG. 3 is a schematic front view showing an alternative electrophotography engine, which includes an intermediary drum or belt;

FIG. 4 is a schematic front view illustrating a layer transfusion assembly for performing layer transfusion steps;

FIG. 5 is a schematic front view showing additional electrophotography engines for providing small-particle finish layers;

FIG. 6 is a flowchart showing a method for constructing a 3D part and support structure in accordance with an exemplary embodiment;

FIG. 7 shows a cross-section through a combined layer including a support material layer, a part material layer, and two finish material layers;

FIG. 8 shows an exemplary 3D part and support structure, where the 3D part includes a large-particle part structure and a small-particle part structure; and

FIG. 9 shows the 3D part of FIG. 8 where the support structure has been removed.

It is to be understood that the attached drawings are for purposes of illustrating the concepts of the invention and may not be to scale. Identical reference numerals have been used, where possible, to designate identical features that are common to the figures.

### DETAILED DESCRIPTION OF THE INVENTION

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

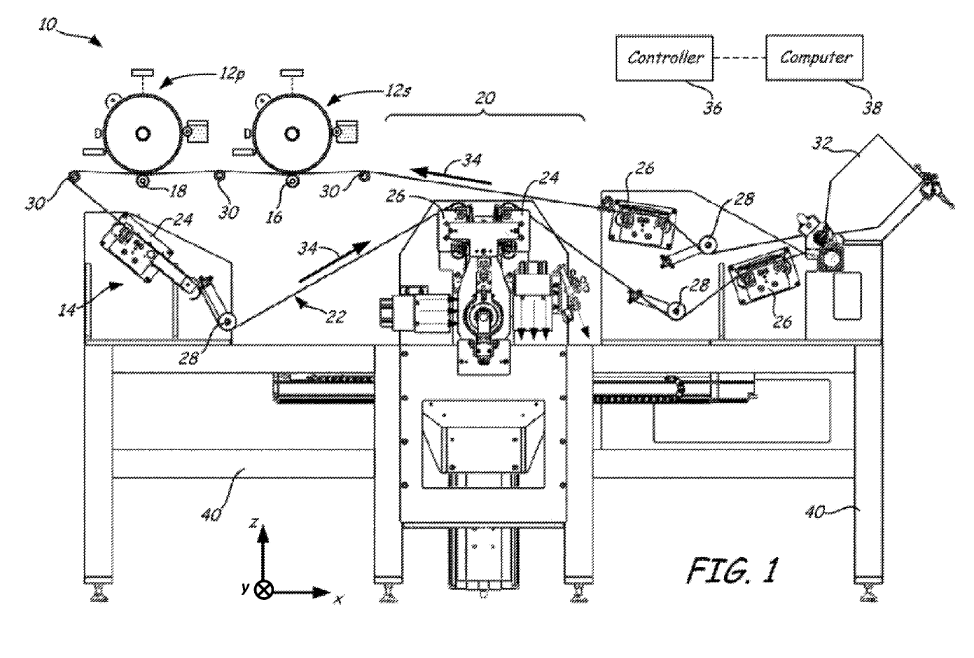

FIGS. 1-4 illustrate an exemplary additive manufacturing system 10, which uses an electrophotography-based additive manufacturing process for printing 3D parts from a part material (e.g., an ABS part material), and associated support structures from a removable support material. As shown in FIG. 1, additive manufacturing system 10 includes a pair of electrophotography (EP) engines 12p and 12s, belt transfer assembly 14, biasing mechanisms 16 and 18, and layer transfusion assembly 20.

Examples of suitable components and functional operations for additive manufacturing system 10 include those disclosed in U.S. Patent Application Publication No. 2013/0077996 (Hanson et al.), entitled “Electrophotography-based additive manufacturing system with reciprocating operation;” in U.S. Patent Application Publication No. 2013/0077997 (Hanson et al.), entitled “Electrophotography-based additive manufacturing system with transfer-medium service loop;” in U.S. Patent Application Publication No. 2013/0186549 (Comb et al.), entitled “Layer transfusion for additive manufacturing;” and in U.S. Patent Application Publication No. 2013/0186558 (Comb et al.), entitled “Layer transfusion with heat capacitor belt for additive manufacturing,” each of which is incorporated herein by reference.

EP engines 12p and 12s are imaging engines for respectively imaging or otherwise developing layers of the part and support materials, where the part and support materials are each preferably engineered for use with the particular architecture of EP engine 12p and 12s. The part material compositionally includes part material particles, and the support compositionally includes support material particles. In an exemplary embodiment, the support material compositionally includes support material particles including a first charge control agent and a first copolymer having aromatic groups, (meth)acrylate-based ester groups, carboxylic acid groups, and anhydride groups; and the part material compositionally includes part material particles including a second charge control agent, and a second copolymer having acrylonitrile units, butadiene units, and aromatic units. As discussed below, the developed part and support layers are transferred to belt transfer assembly 14 (or some other appropriate transfer medium) with biasing mechanisms 16 and 18, and carried to the layer transfusion assembly 20 to produce the 3D parts and associated support structures in a layer-by-layer manner.

In the illustrated configuration, belt transfer assembly 14 includes transfer belt 22, which serves as the transfer medium, belt drive mechanisms 24, belt drag mechanisms 26, loop limit sensors 28, idler rollers 30, and belt cleaner 32, which are configured to maintain tension on the transfer belt 22 while transfer belt 22 rotates in rotational direction 34. In particular, the belt drive mechanisms 24 engage and drive the transfer belt 22, and the belt drag mechanisms 26 function as brakes to provide a service loop design for protecting the transfer belt 22 against tension stress, based on monitored readings from the loop limit sensors 28.

Additive manufacturing system 10 also includes a controller 36, which includes one or more control circuits, microprocessor-based engine control systems, or digitally-controlled raster imaging processor systems, and which is configured to operate the components of additive manufacturing system 10 in a synchronized manner based on printing instructions received from a host computer 38. Host computer 38 includes one or more computer-based systems configured to communicate with controller 36 to provide the print instructions (and other operating information). For example, host computer 38 can transfer information to controller 36 that relates to the individual layers of the 3D parts and support structures, thereby enabling additive manufacturing system 10 to print the 3D parts and support structures in a layer-by-layer manner.

The components of additive manufacturing system 10 are typically retained by one or more frame structures, such as frame 40. Additionally, the components of additive manufacturing system 10 are preferably retained within an enclosable housing (not shown) that prevents ambient light from being transmitted to the components of additive manufacturing system 10 during operation.

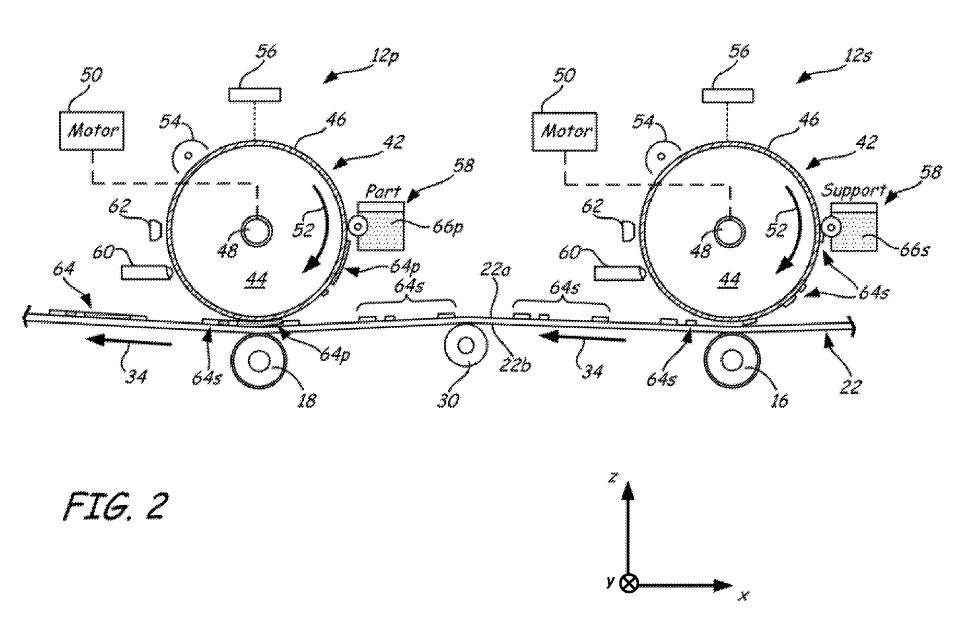

FIG. 2 illustrates EP engines 12p and 12s in additional detail. EP engine 12s (i.e., the upstream EP engine relative to the rotational direction 34 of transfer belt 22) develops layers of support material 66s, and EP engine 12p (i.e., the downstream EP engine relative to the rotational direction 34 of transfer belt 22) develops layers of part material 66p. In alternative configurations, the arrangement of EP engines 12p and 12s can be reversed such that EP engine 12p is upstream from EP engine 12s relative to the rotational direction 34 of transfer belt 22. In other alternative configuration, additive manufacturing system 10 can include one or more additional EP engines for printing layers of additional materials.

In the illustrated configuration, EP engines 12p and 12s utilize identical components, including photoconductor drums 42, each having a conductive drum body 44 and a photoconductive surface 46. Conductive drum body 44 is an electrically-conductive drum (e.g., fabricated from copper, aluminum, tin, or the like) that is electrically grounded and configured to rotate around shaft 48. Shaft 48 is correspondingly connected to drive motor 50, which is configured to rotate the shaft 48 (and the photoconductor drum 42) in rotation direction 52 at a constant rate.

Photoconductive surface 46 is a thin film extending around the circumferential surface of conductive drum body 44, and is preferably derived from one or more photoconductive materials, such as amorphous silicon, selenium, zinc oxide, organic materials, and the like. As discussed below, photoconductive surface 46 is configured to receive latent-charged images of the sliced layers of a 3D part or support structure (or negative images), and to attract charged particles of the part or support material of the present disclosure to the charged (or discharged image areas), thereby creating the layers of the 3D part and support structures.

As further shown, EP engines 12p and 12s also include charging device 54, imager 56, development station 58, cleaning station 60, and discharge device 62, each of which is in signal communication with controller 36. Charging device 54, imager 56, development station 58, cleaning station 60, and discharge device 62 accordingly define an image-forming assembly for surface 46 while drive motor 50 and shaft 48 rotate photoconductor drum 42 in the rotation direction 52.

In the illustrated example, the image-forming assembly for photoconductive surface 46 of EP engine 12s is used to form support material layers 64s of support material 66s, where a supply of support material 66s is retained by development station 58 of EP engine 12s, along with associated carrier particles. Similarly, the image-forming assembly for photoconductive surface 46 of EP engine 12p is used to form part material layers 64p of part material part material 66p, where a supply of part material 66p is retained by development station 58 of EP engine 12p, along with associated carrier particles.

Charging device 54 is configured to provide a uniform electrostatic charge on the photoconductive surface 46 as the photoconductive surface 46 rotates in the rotation direction 52 past the charging device 54. Suitable devices that can be used for the charging device 54 include corotrons, scorotrons, charging rollers, and other electrostatic devices.

Imager 56 is a digitally-controlled, pixel-wise light exposure apparatus configured to selectively emit electromagnetic radiation toward the uniform electrostatic charge on the photoconductive surface 46 as the photoconductive surface 46 rotates in the rotation direction 52 past the imager 56. The selective exposure of the electromagnetic radiation on the photoconductive surface 46 is controlled by the controller 36, and causes discrete pixel-wise locations of the electrostatic charge to be removed (i.e., discharged to ground), thereby forming latent image charge patterns on the photoconductive surface 46. The imager 56 in the EP engine 12p is controlled to provide a latent image charge pattern in accordance with a specified pattern for a particular part material layer 64p, and the imager 56 in the EP engine 12s is controlled to provide a latent image charge pattern in accordance with a specified pattern for a corresponding support material layer 64s.

Suitable devices for imager 56 include scanning laser light sources (e.g., gas or solid state lasers), light emitting diode (LED) array exposure devices, and other exposure device conventionally used in 2D electrophotography systems. In alternative embodiments, suitable devices for charging device 54 and imager 56 include ion-deposition systems configured to selectively deposit charged ions or electrons directly to the photoconductive surface 46 to form the latent image charge pattern. As such, as used herein, the term “electrophotography” includes “ionography.”

Each development station 58 is an electrostatic and magnetic development station or cartridge that retains the supply of part material 66p or support material 66s, preferably in powder form, along with associated carrier particles. The development stations 58 typically function in a similar manner to single or dual component development systems and toner cartridges used in 2D electrophotography systems. For example, each development station 58 can include an enclosure for retaining the part material 66p or support material 66s and carrier particles. When agitated, the carrier particles generate triboelectric charges to attract the part material particles of the part material 66p or the support material particles of the support material 66s, which charges the attracted particles to a desired sign and magnitude, as discussed below.

Each development station 58 typically include one or more devices for transferring the charged part material 66p or support material 66s to the photoconductive surface 46, such as conveyors, fur brushes, paddle wheels, rollers or magnetic brushes. For instance, as the photoconductive surface 46 (having the latent image charge pattern) rotates past the development station 58 in the rotation direction 52, the particles of charged part material 66p or support material 66s are attracted to the appropriately charged regions of the latent image on the photoconductive surface 46, utilizing either charged area development or discharged area development (depending on the electrophotography mode being utilized). This creates successive part material layers 64p and support material layers 64s as the photoconductor drum 42 continues to rotate in the rotation direction 52, where the successive part material layers 64p and support material layers 64s correspond to the successive sliced layers of the digital representation of the 3D part and support structures.

The successive part material layers 64p and support material layers 64s are then rotated with photoconductive surfaces 46 in the rotation direction 52 to a transfer region in which the part material layers 64p and support material layers 64s are successively transferred from the photoconductor drums 42 to the transfer belt 22, as discussed below. While illustrated as a direct engagement between photoconductor drum 42 and transfer belt 22, in some preferred embodiments, EP engines 12p and 12s may also include intermediary transfer drums or belts, as discussed further below. The EP engines 12p and 12s are configured so that the part material layers 64p are transferred onto the transfer belt in registration with the corresponding support material layers 64s to provide combined layers 64.

After a given part material layer 64p or support material layer 64s is transferred from the photoconductor drum 42 to the transfer belt 22 (or an intermediary transfer drum or belt), drive motor 50 and shaft 48 continue to rotate the photoconductor drum 42 in the rotation direction 52 such that the region of the photoconductive surface 46 that previously held the developed layer passes the cleaning station 60. The cleaning station 60 is configured to remove any residual, non-transferred portions of part material 66p or support material 66s from the photoconductive surface 46. Suitable types of cleaning devices for use in the cleaning station 60 include blade cleaners, brush cleaners, electrostatic cleaners, vacuum-based cleaners, and combinations thereof.

After passing the cleaning station 60, the photoconductive surface 46 continues to rotate in the rotation direction 52 such that the cleaned regions of the photoconductive surface 46 pass by the discharge device 62 to remove any residual electrostatic charge on photoconductive surface 46 prior to starting the next cycle. Suitable types of discharge devices 62 include optical systems, high-voltage alternating-current corotrons and/or scorotrons, one or more rotating dielectric rollers having conductive cores with applied high-voltage alternating-current, and combinations thereof.

The transfer belt 22 is a transfer medium for transporting the developed part material layers 64p and support material layers 64s from photoconductor drum 42 (or an intermediary transfer drum or belt) to the layer transfusion assembly 20 (FIG. 1). Examples of suitable types of transfer belts 22 include those disclosed in Comb et al. in the aforementioned U.S. Patent Application Publication No. 2013/0186549 and U.S. Patent Application Publication No. 2013/0186558 (both to Comb et al.). The transfer belt 22 includes a front surface 22a and a rear surface 22b, where the front surface 22a faces the photoconductive surfaces 46 of photoconductor drums 42 and the rear surface 22b is in contact with biasing mechanisms 16 and 18.

Biasing mechanisms 16 and 18 are configured to induce electrical potentials through transfer belt 22 to electrostatically attract the part material layers 64p and support material layers 64s from EP engines 12p and 12s, respectively, to the transfer belt 22. Because the part material layers 64p and support material layers 64s each represent only a single layer increment in thickness at this point in the process, electrostatic attraction is suitable for transferring the part material layers 64p and support material layers 64s from the EP engines 12p and 12s to the transfer belt 22.

Preferably, the controller 36 rotates the photoconductor drums 42 of EP engines 12p and 12s at the same rotational rates, such that the tangential velocity of the photoconductive surfaces 46 are synchronized with the line speed of the transfer belt 22 (as well as with any intermediary transfer drums or belts). This allows the additive manufacturing system 10 to develop and transfer the part material layers 64p and support material layers 64s in coordination with each other from separate developed images. In particular, as shown, each part material layer 64p is transferred to transfer belt 22 in proper registration with each support material layer 64s to produce the combined layer 64. As discussed below, this allows the part material layers 64p and support material layers 64s to be transfused together. To enable this, the part material 66p and support material 66s preferably have thermal properties and melt rheologies that are the same or substantially similar. Within the context of the present invention, “substantially similar thermal properties and melt rheologies” should be interpreted to be within 20% of regularly measured properties such as glass transition temperature, melting point and melt viscosity. As can be appreciated, some combined layers 64 transported to layer transfusion assembly 20 may only include support material 66s or may only include part material 66p, depending on the particular support structure and 3D part geometries and layer slicing.

In an alternative and generally less-preferred configuration, part material layers 64p and support material layers 64s may optionally be developed and transferred along transfer belt 22 separately, such as with alternating part material layers 64p and support material layers 64s. These successive, alternating layers 64p and 64s may then be transported to layer transfusion assembly 20, where they may be transfused separately to print the 3D part and support structure.

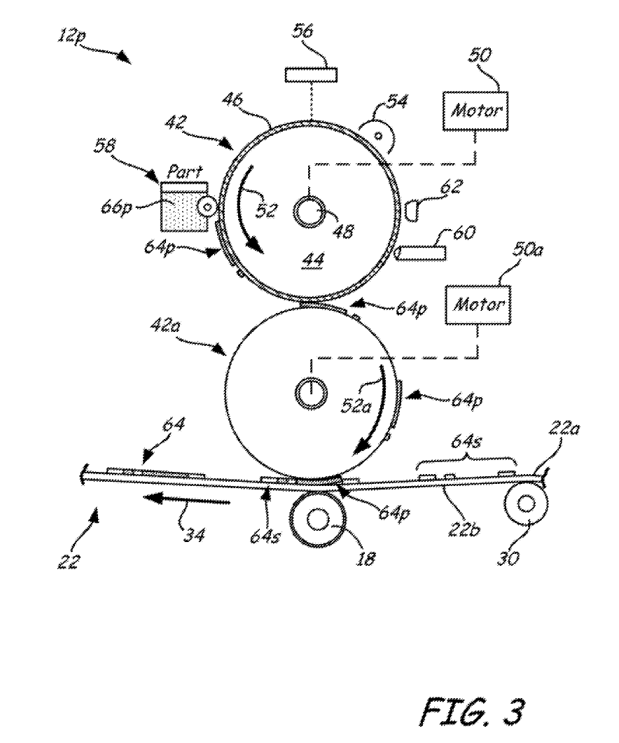

In some configurations, one or both of EP engines 12p and 12s can also include one or more intermediary transfer drums or belts between the photoconductor drum 42 and the transfer belt 22. For example, FIG. 3 illustrates an alternate configuration for an EP engine 12p that also includes an intermediary drum 42a. The intermediary drum 42a rotates in a rotation direction 52a opposite to the rotation direction 52, under the rotational power of drive motor 50a. Intermediary drum 42a engages with photoconductor drum 42 to receive the developed part material layers 64p from the photoconductor drum 42, and then carries the received part material layers 64p and transfers them to the transfer belt 22.

In some configurations, the EP engine 12s (FIG. 2) can use a same arrangement using an intermediary drum 42a for carrying the developed support material layers 64s from the photoconductor drum 42 to the transfer belt 22. The use of such intermediary transfer drums or belts for EP engines 12p and 12s can be beneficial for thermally isolating the photoconductor drum 42 from the transfer belt 22, if desired.

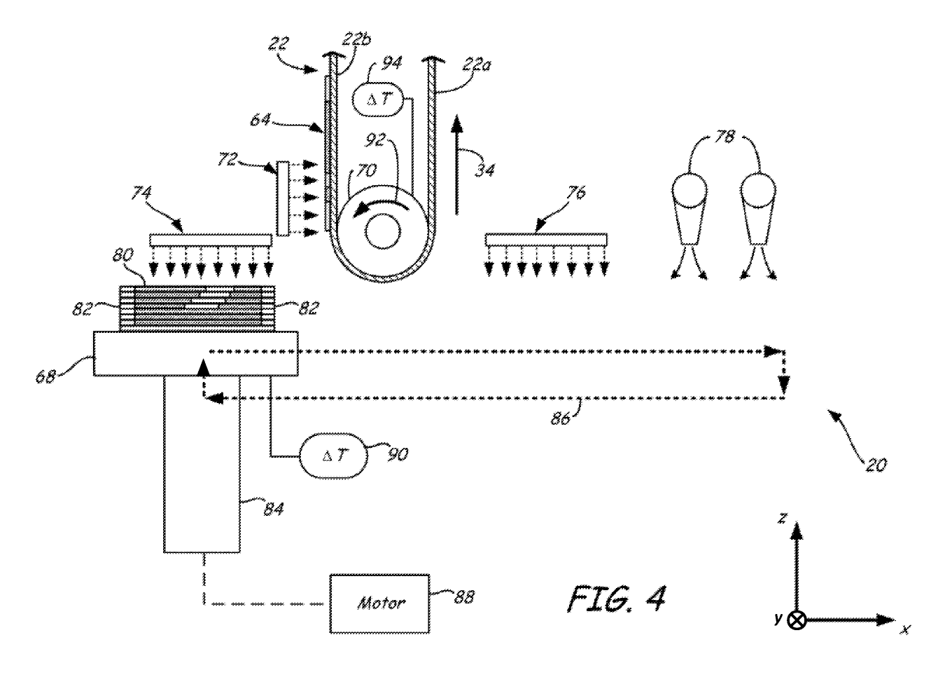

FIG. 4 illustrates an exemplary configuration for the layer transfusion assembly 20. As shown, the layer transfusion assembly 20 includes build platform 68, nip roller 70, heaters 72 and 74, post-fuse heater 76, and air jets 78 (or other cooling units). Build platform 68 is a platform assembly or platen that is configured to receive the heated combined layers 64 (or separate part material layers 64p and support material layers 64s) for printing a 3D part 80 and support structure 82, in a layer-by-layer manner. In some configurations, the build platform 68 may include removable film substrates (not shown) for receiving the combined layers 64, where the removable film substrates may be restrained against build platform using any suitable technique (e.g., vacuum drawing, removable adhesive, mechanical fastener, and the like).

The build platform 68 is supported by gantry 84, which is a gantry mechanism configured to move build platform 68 along the z-axis and the x-axis in a reciprocating rectangular motion pattern 86, where the primary motion is back-and-forth along the x-axis. Gantry 84 may be operated by a motor 88 based on commands from the controller 36, where the motor 88 can be an electrical motor, a hydraulic system, a pneumatic system, or the like.

In the illustrated configuration, the build platform 68 is heatable with heating element 90 (e.g., an electric heater). Heating element 90 is configured to heat and maintain the build platform 68 at an elevated temperature that is greater than room temperature (e.g., about 25° C.), such as at a desired average part temperature of 3D part 80 and support structure 82, as discussed by Comb et al. in the aforementioned U.S. Patent Application Publication No. 2013/0186549 and U.S. Patent Application Publication No. 2013/0186558. This allows build platform 68 to assist in maintaining the 3D part 80 and support structure 82 at the desired average part temperature.

Nip roller 70 is a heatable element or a heatable layer transfusion element, which is configured to rotate around a fixed axis with the movement of transfer belt 22. In particular, nip roller 70 may roll against the rear surface 22b in rotation direction 92 while the transfer belt 22 rotates in the rotation direction 34. In the illustrated configuration, nip roller 70 is heatable with heating element 94 (e.g., an electric heater). Heating element 94 is configured to heat and maintain nip roller 70 at an elevated temperature that is greater than the room temperature (e.g., 25° C.), such as at a desired transfer temperature for combined layers 64.

Heater 72 includes one or more heating device (e.g., an infrared heater or a heated air jet) configured to heat the combined layers 64 to a temperature near an intended transfer temperature of the part material 66p and support material 66s, such as at least a fusion temperature of the part material 66p and support material 66s, preferably prior to reaching nip roller 70. Each combined layer 64 preferably passes by (or through) heater 72 for a sufficient residence time to heat the combined layer 64 to the intended transfer temperature. Heater 74 may function in the same manner as heater 72, and heats the top surfaces of 3D part 80 and support structure 82 to an elevated temperature, such as at the same transfer temperature as the heated combined layers 64 (or other suitable elevated temperature).

As mentioned above, the support material 66s used to print support structure 82 preferably has thermal properties (e.g., glass transition temperature) and a melt rheology that are similar to or substantially the same as the thermal properties and the melt rheology of the part material 66p used to print 3D part 80. This enables the part material 66p of the part material layer 64p and the support material 66s of the support material layer 64s to be heated together with heater 74 to substantially the same transfer temperature, and also enables the part material 66p and support material 66s at the top surfaces of 3D part 80 and support structure 82 to be heated together with heater 74 to substantially the same temperature. Thus, the part material layers 64p and the support material layers 64s can be transfused together to the top surfaces of 3D part 80 and support structure 82 in a single transfusion step as combined layer 64. This single transfusion step for transfusing the combined layer 64 is typically impractical without sufficiently matching the thermal properties and the melt rheologies of the part material 66p and support material 66s.

Post-fuse heater 76 is located downstream from nip roller 70 and upstream from air jets 78, and is configured to heat the transfused layers to an elevated temperature to perform a post-fuse or heat-setting operation. Again, the similar thermal properties and melt rheologies of the part and support materials enable the post-fuse heater 76 to post-heat the top surfaces of 3D part 80 and support structure 82 together in a single post-fuse step.

Prior to printing 3D part 80 and support structure 82, build platform 68 and nip roller 70 may be heated to their desired temperatures. For example, build platform 68 may be heated to the average part temperature of 3D part 80 and support structure 82 (due to the similar melt rheologies of the part and support materials). In comparison, nip roller 70 may be heated to a desired transfer temperature for combined layers 64 (also due to the similar thermal properties and melt rheologies of the part and support materials).

During the printing operation, transfer belt 22 carries a combined layer 64 past heater 72, which may heat the combined layer 64 and the associated region of transfer belt 22 to the transfer temperature. Suitable transfer temperatures for the part and support materials include temperatures that exceed the glass transition temperatures of the part material 66p and the support material 66s, which are preferably similar or substantially the same, and where the part material 66p and support material 66s of combined layer 64 are softened but not melted (e.g., to a temperature ranging from about 140° C. to about 180° C. for an ABS part material).

As further shown in the exemplary configuration of FIG. 4, during operation, gantry 84 moves the build platform 68 (with 3D part 80 and support structure 82) in a reciprocating rectangular motion pattern 86. In particular, the gantry 84 moves build platform 68 along the x-axis below, along, or through heater 74. Heater 74 heats the top surfaces of the 3D part 80 and support structure 82 to an elevated temperature, such as the transfer temperatures of the part and support materials. As discussed by Comb et al. in the aforementioned U.S. Patent Application Publication No. 2013/0186549 and U.S. Patent Application Publication No. 2013/0186558, heaters 72 and 74 can heat the combined layers 64 and the top surfaces of the 3D part 80 and support structure 82 to about the same temperatures to provide a consistent transfusion interface temperature. Alternatively, heaters 72 and 74 can heat the combined layers 64 and the top surfaces of the 3D part 80 and support structure 82 to different temperatures to attain a desired transfusion interface temperature.

The continued rotation of transfer belt 22 and the movement of build platform 68 align the heated combined layer 64 with the heated top surfaces of the 3D part 80 and support structure 82 with proper registration along the x-axis. The gantry 84 continues to move the build platform 68 along the x-axis at a rate that is synchronized with the tangential velocity of the transfer belt 22 (i.e., the same directions and speed). This causes rear surface 22b of the transfer belt 22 to rotate around nip roller 70 and brings the heated combined layer 64 into contact with the top surfaces of 3D part 80 and support structure 82. This presses the heated combined layer 64 between the front surface 22a of the transfer belt 22 and the heated top surfaces of 3D part 80 and support structure 82 at the location of nip roller 70, which at least partially transfuses the heated combined layer 64 to the top layers of 3D part 80 and support structure 82.

As the transfused combined layer 64 passes the nip of nip roller 70, the transfer belt 22 wraps around nip roller 70 to separate and disengage the transfer belt from the build platform 68. This assists in releasing the transfused combined layer 64 from the transfer belt 22, enabling the transfused combined layer 64 to remain adhered to the 3D part 80 and the support structure 82, thereby adding a new layer to the 3D part and the support structure 82. Maintaining the transfusion interface temperature at a transfer temperature that is higher than the glass transition temperatures of the part and support materials, but lower than their fusion temperatures, enables the heated combined layer 64 to be hot enough to adhere to 3D part 80 and support structure 82, while also being cool enough to readily release from transfer belt 22. Additionally, as discussed earlier, the similar thermal properties and melt rheologies of the part and support materials allow them to be transfused in the same step.

After release, the gantry 84 continues to move the build platform 68 along the x-axis to the post-fuse heater 76. At the post-fuse heater 76, the top-most layers of 3D part 80 and support structure 82 (including the transfused combined layer 64) are preferably heated to at least the fusion temperature of the part and support materials in a post-fuse or heat-setting step. This melts the part and support materials of the transfused combined layer 64 to a highly fusible state such that polymer molecules of the transfused combined layer 64 quickly inter-diffuse to achieve a high level of interfacial entanglement with the 3D part 80 and the support structure 82.

The gantry 84 continues to move the build platform 68 along the x-axis past post-fuse heater 76 to air jets 78, the air jets 78 blow cooling air towards the top layers of 3D part 80 and support structure 82. This actively cools the transfused layer 64 down to the average part temperature, as discussed by Comb et al. in the aforementioned U.S. Patent Application Publication No. 2013/0186549 and U.S. Patent Application Publication No. 2013/0186558.

To assist in keeping 3D part 80 and support structure 82 at the desired average part temperature, in some arrangements, one or both of the heater 74 and post-fuse heater 76 can be configured to operate to heat only the top-most layers of 3D part 80 and support structure 82. For example, in embodiments in which heaters 72, 74 and 76 are configured to emit infrared radiation, 3D part 80 and support structure 82 can include heat absorbers or other colorants configured to restrict penetration of the infrared wavelengths to within only the top-most layers. Alternatively, heaters 72, 74 and 76 can be configured to blow heated air across the top surfaces of 3D part 80 and support structure 82. In either case, limiting the thermal penetration into 3D part 80 and support structure 82 allows the top-most layers to be sufficiently transfused, while also reducing the amount of cooling required to keep 3D part 80 and support structure 82 at the desired average part temperature.

The EP engines 12p and 12s have an associated maximum printable area. For example, the EP engines in the NexPress SX3900 have a maximum printing width in the cross-track direction (i.e., the y-direction) of about 340 mm, and a maximum printing length in the in-track direction (i.e., the x-direction) of about 904 mm. When building a 3D part 80 and support structure 82 having a footprint that is smaller than the maximum printable area of the EP engines 12p and 12s, the gantry 84 next actuates the build platform 68 downward, and moves the build platform 68 back along the x-direction following the reciprocating rectangular motion pattern 86 to an appropriate starting position in the x-direction in proper registration for transfusing the next combined layer 64. In some embodiments, the gantry 84 may also actuate the build platform 68 with the 3D part 80 and support structure 82 upward to bring it into proper registration in the z-direction for transfusing the next combined layer 64. (Generally the upward movement will be smaller than the downward movement to account for the thickness of the previously printed layer.) The same process is then repeated for each layer of 3D part 80 and support structure 82.

In some arrangements, the 3D part 80 constructed by the additive manufacturing system 10 is encased laterally (i.e., in the x- and y-dimensions of the build plane) within the support structure 82, such as shown in FIG. 4. This has the advantage that it provides improved dimensional integrity and surface quality for the 3D part 80 when using a layer transfusion assembly 20 having a reciprocating build platform 68 and nip roller 70.

After the construction operation is completed, the resulting 3D part 80 and support structure 82 can be removed from additive manufacturing system 10 and undergo one or more post-printing operations. For example, the support structure 82 derived from the support material 66s can be sacrificially removed from the 3D part 80, such as by using an appropriate aqueous-based solution (e.g., an aqueous alkali solution). Using this technique, the support structure 82 may be at least partially dissolved in the solution, separating it from 3D part 80 in a hands-free manner. In such cases, the support material 66s is chosen to be soluble in the aqueous-based solution while the part material 66p is chosen to be insoluble.

In prior art arrangements, the size of the 3D parts 80 that could be fabricated was limited by the maximum printable area of the EP engines 12p and 12s. It would be very costly to develop specially designed EP engines 12p and 12s having maximum printable areas that are larger than those used in typical printing systems. Commonly assigned, co-pending U.S. Patent Application Ser. No. 62/286,490 to C. Sreekumar et al., entitled “Large format electrophotographic 3D printer,” which is incorporated herein by reference, describes methods for using EP engines to produce large parts by printing into a plurality of tile regions on a large build platform.

The present invention provides a system for fabricating 3D parts having a high resolution and a controlled surface finish. This is accomplished by forming the 3D parts using two different part materials having different sizes. A first part material having a larger particle size is used to form a first portion of the 3D part, while a second part material having a smaller particle size is used to form a second portion of the 3D part. In an exemplary configuration, the second part material is used to form exterior surfaces of the 3D part so that the smaller particle size provides the ability to control the surface shape with a higher resolution, and to provide smoother surface textures than could be provided using only the first part material.

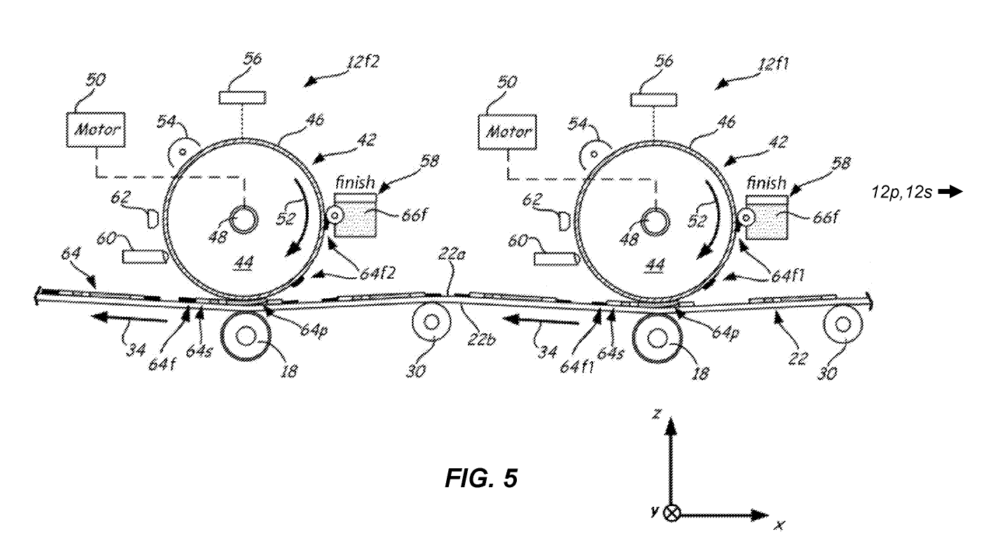

The method of the present invention is practiced using an additive manufacturing system 10 similar to that which was described relative to FIGS. 1-4, except that the EP engine 12P is used to print the first part material and one or more additional EP engines are provided to print the second part material. FIG. 5 shows two additional EP engines 12f1 and 12f2 that are used in combination with the EP engines 12s and 12p of FIG. 2 to form 3D parts in accordance with the present invention. In an exemplary embodiment, the EP engines 12f1 and 12f2 are located along the path of the transfer belt 22 downstream of the EP engines 12s and 12p of FIG. 2. In other embodiments, the EP engines can be arranged in a different order. For example, the EP engines 12f1 and 12f2 can be positioned upstream of the EP engines 12s and 12p.

EP engines 12f1 and 12f2 operate in an analogous fashion to the EP engines 12s and 12p of FIG. 2. EP engines 12f1 and 12f2 are used to print respective finish material layers 64f1 and 64f2 using a second part material (i.e., finish material 66f) that compositionally includes second part material particles. Preferably, the average size of the first part material particles of the first part material 66p printed by EP engine 12p is at least two times the average size of the second part material particles of the finish material 66f printed by the EP engines 12f1 and 12f2. In some embodiments, the part material particles of the finish material 66f has the same chemical composition as the part material particles of the part material 66p, but are manufactured to have a different average particle size.

The EP engine 12p is used to print a first portion of the 3D part, and the EP engines 12f1 and 12f2 are used to print a second portion of the 3D part. Preferably, the second portion of the 3D part includes any exterior surfaces of the 3D part that will be visible to an observer. The smaller particle size of the finish material 66f enables the second portion of the 3D part to be printed with a higher resolution and with a controlled surface finish than the first portion of the 3D part.

In the configuration of FIG. 5, EP engine 12f1 prints a first finish material layer 64f1, which is transferred to the transfer belt 22 in registration with the previously printed support material layer 64s and part material layer 64p. EP engine 12f2 then prints a second finish material layer 64f2 in registration with the previously printed layers. In the illustrated configuration, the second finish material layer 64f2 is transferred to the transfer belt 22 over the top of the first finish material layer 64f1 to provide a combined finish material layer 64f. In an exemplary configuration, the particles of the finish material 66f have a particle size which is approximately half that of the particles of the part material 66p, and the finish material layers 64f1, 64f2 have a thickness which is approximately half of the thickness of the part material layer. The combined finish material layer 64f will then have approximately the same thickness as the part material layer 64p. In other embodiments, more than two EP engines can be used to print the finish material 66f. For example, three EP engines can be used to print finish material layers, each having a thickness which is approximately ⅓ that of the part material layer.

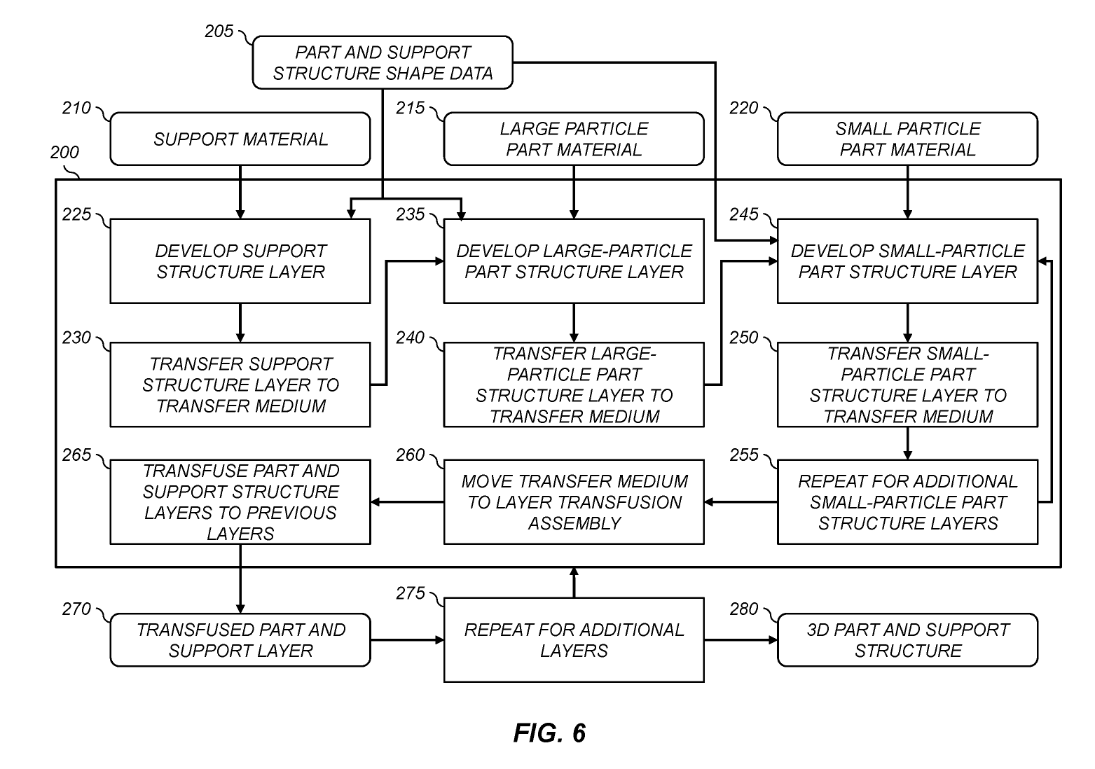

FIG. 6 shows a flow chart summarizing a method for constructing a 3D part and support structure 280 from a support material 210, a large-particle part material 215 and a small-particle part material 220 in accordance with the present invention. The part to be constructed is specified using part and support structure shape data 205, which is a digital representation specifying the desired shape of the 3D part and support structure 280. The shape data for the 3D part specifies a first portion to be printed with the large-particle part material 215 and a second portion to be printed with the small-particle part material 220. Common forms of such digital representations would include the well-known AMF and STL file formats. Generally, the first portion to be printed with the large-particle part material 215 will correspond to an inner bulk portion of the 3D part and the second portion to be printed with the small-particle part material 220 will correspond to a surface portion of the 3D part. Appropriate definition of the shape data for the second portion to be printed with the small-particle part material 220 enables control of the surface finish to be provided onto the 3D part. For example, a smooth finish or a textured finish can be provided on the surface of the 3D part.

The 3D part and support structure 280 is formed in a layer-by-layer manner using a layer formation process 200. A develop support structure layer step 225 is used to develop a support material layer 64s (FIG. 2) of the support structure 82 (FIG. 4) from the support material 66s (FIG. 2) using a first EP engine 12s (FIG. 2). The support material layer 64s corresponds to the content of the support structure 82 to be constructed in a first layer. The developed support material layer 64s is transferred from the first EP engine 12s to a transfer belt 22 (FIG. 2), or some other appropriate transfer medium, using a transfer support structure layer to transfer medium step 230.

Similarly, a develop large-particle part structure layer step 235 is used to develop a part material layer 64p (FIG. 2) corresponding to a first portion of the 3D part 80 (FIG. 4) from the part material 66p (FIG. 2) using a second EP engine 12p (FIG. 2). The part material layer 64p corresponds to the content of the first portion of the 3D part 80 to be constructed in the first layer. The developed part material layer 64p is then transferred from the second EP engine 12p to the transfer belt 22 using a transfer large-particle part structure layer to transfer medium step 240. As discussed earlier, the developed part material layer 64p is preferably transferred to the transfer belt 22 in registration with the developed support material layer 64s.

A develop small-particle part structure layer step 245 is then used to develop a finish material layer 64f1 (FIG. 5) corresponding to a second portion of the 3D part 80 (FIG. 4) from the finish material 66f (FIG. 5) using EP engine 12f1 (FIG. 5). The finish material layer 64f1 corresponds to the content of the second portion of the 3D part 80 to be constructed in the first layer. The developed finish material layer 64f1 is then transferred from the EP engine 12f1 to the transfer belt 22 in registration with the support material layer 64s and the part material layer 64p using a transfer small-particle part structure layer to transfer medium step 250.

A repeat for additional small-particle part structure layers step 255 is used to repeat the develop small-particle part structure layer step 245 and the transfer small-particle part structure layer to transfer medium step 250 to provide one or more additional finish material layers 64f2 (FIG. 5). Generally, the additional finish material layers 64f2 will be transferred to the transfer belt over the top of the first finish material layer 64f1 to provide a combined finish material layer 64f (FIG. 5). The support material layer 64s, the part material layer 64p and the finish material layer 64f together form combined layer 64 (FIG. 5). In some configurations, the finish material layers 64f1, 64f2 are each printed using separate EP engines 12f1, 12f2 as illustrated in FIG. 5. In other embodiments, the finish material layers 64f1, 64f2 can be printed by passing the transfer belt 22 past a single EP engine 12f1 for a plurality of passes.

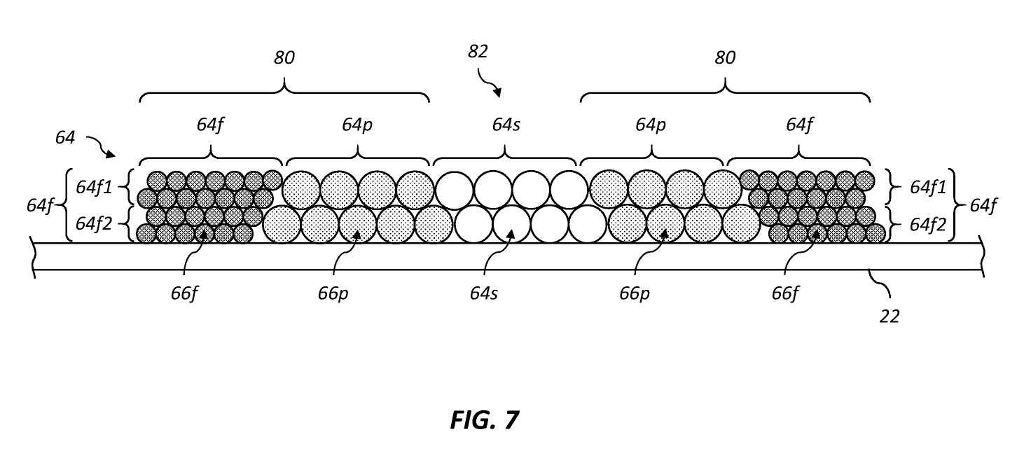

FIG. 7 shows a cross section through a combined layer 64 of an exemplary 3D part and support structure 280 (FIG. 6) formed on the transfer belt 22. The combined layer 64 includes a support material layer 64s, a part material layer 64p, and a finish material layer 64f. The finish material layer 64f is made by overlaying two finish material layers 64f1, 64f2. In this example, the combined layer 64 a part structure corresponding to a layer of the 3D part 80 surrounding a central support structure 82. An inner bulk portion of the part structure of the 3D part 80 is formed using the large-particle part material 66p, while an outer surface portion of the part structure is formed using the small-particle finish material 66f.

Returning to a discussion of FIG. 6, a move transfer medium to layer transfusion assembly step 260 is then used to move the transfer medium (e.g., transfer belt 22) bearing the developed support material layer 64s, developed large-particle part material layer 64p, and developed small-particle finish material layer 64f to a layer transfusion assembly 20 (FIG. 4). The transfer belt 22 is aligned with an appropriate starting position of the build platform 68 (FIG. 4) of the layer transfusion assembly 20. A transfuse part and support structure layers to previous layers step 265 is then used to transfuse the developed support material layer 64s, developed large-particle part material layer 64p, and developed small-particle finish material layer 64f, adding a layer to the 3D part 80 and support structure 82, providing a transfused part and support layer 270.

A repeat for additional layers step 275 is used to repeat the layer formation process 200 for each of the layers that make up the 3D part 80 and support structure 82 to provide 3D part and support structure 280. After repeating the layer formation process 200 for all of the layers, the resulting 3D part and support structure 280 is removed from the additive manufacturing system 10 and post-printing operations can be used to remove the support structure 82, leaving the final 3D part 80.

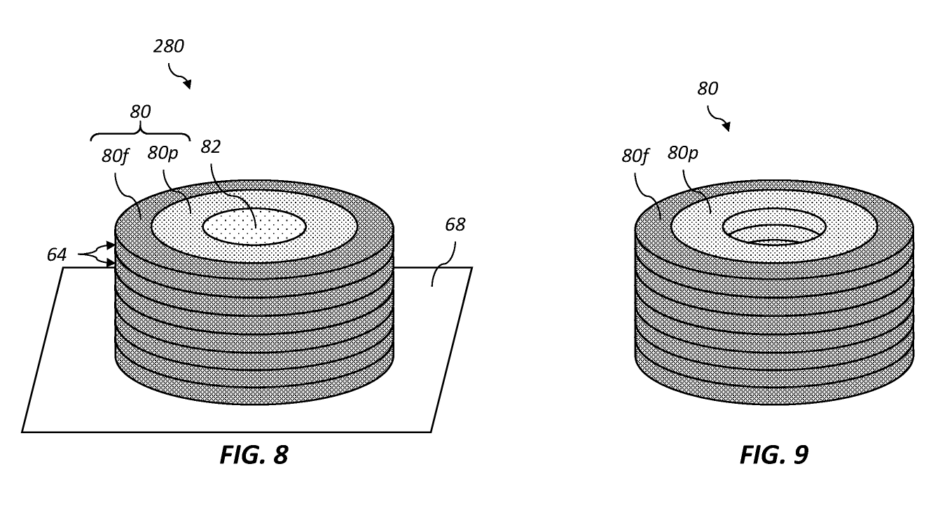

FIG. 8 shows an exemplary 3D part and support structure 280 formed using the method of FIG. 6. The 3D part and support structure 280 includes 3D part 80 and support structure 82. The 3D part includes a first portion (part material structure 80p) formed using the large-particle part material 66p (FIG. 5), and a second portion (finish material structure 80f) formed using the small-particle finish material 66f. The 3D part and support structure 280 is formed using a plurality of combined layers 64, which have been transfused in a layer-by-layer fashion onto the build platform 68. The combined layer 64 shown in FIG. 7 is a cross-sectional through one of the layers that make up the 3D part and support structure 280.

FIG. 9 shows a 3D part 80 corresponding to that shown in FIG. 8, where the 3D part and support structure 280 has been removed from the build platform 68 and the support structure 82 has been removed. In some embodiments, the support structure can be removed by at least partially dissolving it in an appropriate aqueous-based solution (e.g., an aqueous alkali solution). The exterior surface of the 3D part 80 is formed using the finish material structure 80f, which was made using the small-particle finish material 66f (FIG. 5) to provide a higher resolution and a smoother surface finish, while the inner portion of the 3D part 80 is formed using the part material structure 80p, which was made using the large-particle part material 66p (FIG. 5).

In some embodiments, the layer-by layer process described with respect to FIG. 6 can be combined with the tile-based approach described in the aforementioned U.S. Patent Application No. 62/286,490 to provide a large format printing system capable of producing high-resolution 3D parts.

The present invention has been described with respect to electrophotography-based additive manufacturing systems. It will be obvious to one skilled in the art that it can also be applied to any type of additive manufacturing system that prints 3D parts and support structures on a layer-by-layer basis by depositing layers of part materials and support materials onto a transfer medium and then transfusing the layers together with previously-printed layers.

The invention has been described in detail with particular reference to certain preferred embodiments thereof, but it will be understood that variations and modifications can be effected within the spirit and scope of the invention.

### PARTS LIST

10 additive manufacturing system
12f1 electrophotography (EP) engine
12f2 electrophotography (EP) engine
12p electrophotography (EP) engine
12s electrophotography (EP) engine
14 belt transfer assembly
16 biasing mechanism
18 biasing mechanism
20 layer transfusion assembly
22 transfer belt
22a front surface
22b rear surface
24 belt drive mechanism
26 belt drag mechanism
28 loop limit sensor
30 idler roller
32 belt cleaner
34 rotational direction
36 controller
38 host computer
40 frame
42 photoconductor drum
42a intermediary drum
44 conductive drum body
46 photoconductive surface
48 shaft
50 drive motor
50a drive motor
52 rotation direction
52a rotation direction
54 charging device
56 imager
58 development station
60 cleaning station
62 discharge device
64 combined layer
64f finish material layer
64f1 finish material layer
64f2 finish material layer
64p part material layer
64s support material layer
66f finish material
66p part material
66s support material
68 build platform
70 nip roller
72 heater
74 heater
76 post-fuse heater
78 air jets
80 3D part
80p part material structure
80f finish material structure
82 support structure
84 gantry
86 motion pattern
88 motor
90 heating element
92 rotation direction
94 heating element
200 layer formation process
205 part and support structure shape data
210 support material
215 large-particle part material
220 small-particle part material
225 develop support structure layer step
230 transfer support structure layer to transfer medium step
235 develop large-particle part structure layer step
240 transfer large-particle part structure layer to transfer medium step
245 develop small-particle part structure layer step
250 transfer small-particle part structure layer to transfer medium step
255 repeat for additional small-particle part structure layers step
260 move transfer medium to layer transfusion assembly step
265 transfuse part and support structure layers to previous layers step
270 transfused part and support layer
275 repeat for additional tile regions and layers step
280 3D part and support structure

1. A method for printing a three-dimensional part and a support structure with an electrophotography-based additive manufacturing system, the method comprising:
providing a removable support material compositionally including support material particles;
providing a first part material compositionally including first part material particles;
providing a second part material compositionally including second part material particles, wherein an average size of the first part material particles is at least two times an average size of the second part material particles;
developing a support layer of the support structure from the support material with a first electrophotography engine;
transferring the developed support layer from the first electrophotography engine to a transfer medium;
developing a large-particle part layer corresponding to a predefined first portion of the three-dimensional part from the first part material with a second electrophotography engine;
transferring the developed large-particle part layer from the second electrophotography engine to the transfer medium;
developing a plurality of small-particle part layers corresponding to a predefined second portion of the three-dimensional part from the second part material with one or more additional electrophotography engines;
transferring the developed small-particle part layers from the one or more additional electrophotography engines to the transfer medium; and
transfusing the transferred support layer, large-particle part layer and small-particle part layers together to previously-printed layers using a layer transfusion assembly.

2. The method of claim 1, wherein the first portion of the three-dimensional part corresponds to a bulk portion of the three-dimensional part and the second portion of the three-dimensional part corresponds to a surface portion of the three-dimensional part.

3. The method of claim 1, wherein the small-particle part layers are developed using multiples passes with a single additional electrophotography engine.

4. The method of claim 1, wherein the plurality of small-particle part layers are developed using a corresponding plurality of additional electrophotography engines.

5. The method of claim 1, wherein the developed support layer, the developed large-particle part layer, and the developed small-particle part layers are transferred to the transfer medium in registration with each other, and wherein the transferred support layer, large-particle part layer and small-particle part layers are simultaneously transfused onto the previously-printed layers.

6. The method of claim 1, wherein the layer transfusion assembly includes a build platform having a build surface onto which the three-dimensional part and the support structure are constructed.

7. The method of claim 1, wherein the transfer medium is a transfer belt that travels around a belt path to transport the transferred part and support layers to the layer transfusion assembly.

8. The method of claim 7, wherein the transferred part and support layers are transfused to the previously-printed layers at a nip formed where the transfer belt passes between a nip roller and a build platform onto which the previously-printed layers were constructed.

9. The method of claim 8, wherein the layer transfusion assembly further includes a gantry adapted to move the build platform past the nip roller in synchronization with the motion of the transfer belt such that the build platform moves at a velocity which is substantially the same as a tangential velocity of the transfer belt at the nip.

10. The method of claim 1, wherein the layer transfusion assembly includes one or more heaters to heat the transferred support layer, large-particle part layer and small-particle part layers on the transfer medium to a predefined transfusion interface temperature.

11. The method of claim 1, wherein the layer transfusion assembly includes one or more heaters to heat a top surface of the previously-printed layers to a predefined transfusion interface temperature.

12. The method of claim 1, wherein the layer transfusion assembly includes one or more heaters to heat the transfused support layer, large-particle part layer and small-particle part layers to a predefined fusion temperature thereby fusing the transfused heat and support layers to the previously-printed layers.

13. The method of claim 1, wherein the large-particle part material, the small-particle part material and the support material have substantially similar thermal properties and melt rheologies.

14. The method of claim 1, further including removing the support structure from the three-dimensional part.

15. The method of claim 14, wherein the support material is soluble in an aqueous-based solution, and wherein the support structure is removed by at least partially dissolving the support material of the support structure in the aqueous-based solution.
